(19) United States
(12) Patent Application Publication
(10) Pub. No.: US 2006/0139670 A1
(43) Pub. Date: Jun. 29, 2006

(54) Method and system for correcting output of printer devices

(76) Inventor: Robert S. Hoblit, Knightdale, NC (US)

Correspondence Address: SAWYER LAW GROUP LLP, PO BOX 51418, PALO ALTO, CA, 94303, US

(21) Appl. No.: 11/023,913

(22) Filed: Dec. 27, 2004

(51) Int. Cl. G06K 15/00

(52) U.S. Cl. 358/1.12; 358/504

(57) ABSTRACT

System and method for correcting the output provided by printer devices. Output data is received at a printer device, the output data describing intended output for the printer device, where the printer device prints printed output based on the output data. The method shifts the position of at least one non-matching portion of future printed output that does not match the intended output due to a technical failure of the printer device. The shifting causes the quality of non-matching portions in future printed output of the printer device to be improved.

### FIELD OF THE INVENTION

The present invention relates to printer devices, and more particularly to the correction of errors or low quality in output provided by printer devices.

### BACKGROUND OF THE INVENTION

Printer devices are used in a wide variety of applications to provide a hard copy of output data or information on a print medium that is easily accessed and holds its data reliably, such as paper. Printer devices can use any of a variety of technology to print text or images, such as laser printers, copiers/toners, ink printer, thermal printers, impact or dot-matrix printers, or other types of devices or materials. Printer devices are often used to provide a convenient and inexpensive data record when other methods are not as convenient or practical. For example, many businesses have a printer device located at the point-of-sale (POS) in their stores, where the printer device provides a paper receipt to a customer who has purchased various items at the store. The paper receipt typically lists in columns each name or type of item purchased, the quantity of items purchased, and the price paid by the customer for each item as well as the total price. Other information can also be included on the receipt, such as the weight of items, discounts received, previous purchasing history of the customer, coupons, a short description of each item, etc.

Thermal printers output text and images on a medium such as paper by using a printing head that includes a heating element having wires or similar components. The heating element typically prints a horizontal line of small dots on the paper at one time by heating only particular wires that correspond to the dots intended to be printed. By printing successive lines of horizontal dots, text and images can be formed. Thermal printers have some advantages over other types of printers, such as speed, low cost, and quiet operation, which make them well-suited to point-of-sale operations such as providing receipts for customers.

One problem that can occur with thermal printer devices, and other types of printer devices, is that the printer device may produce output errors due to malfunctions or other technical problems of the printing head that significantly reduce the quality of the output. For example, in thermal printer devices, some of the wires of the printing head may malfunction or fail and not print dots on the paper. This causes the same dots to not be printed in every successive row of dots that the printer outputs, i.e., in an entire column, obscuring any text or images that were intended to be printed. Furthermore, such a hardware failure is likely to be permanent in a thermal printer head, until the defective components can be replaced. In a POS environment, printer devices often generate a large proportion of their output in columns, and certain columns of the printed receipt are important to the customer, such as the quantity or weight of the items purchased, as well as the columns displaying the prices of the items. When a printing head is damaged and prints important columns and other areas of the receipt in poor quality, the customer and retailer both suffer. Other types of printers, such as dot matrix printers or other impact printers, may similarly develop failures that cause certain areas of the printing head to not print desired output correctly.

Accordingly, what is needed is an apparatus or method for determining when output of printing devices is poor or defective, and to correct for the defects in the output until failed components of the printer device can be repaired or replaced. The present invention addresses such a need.

### SUMMARY OF THE INVENTION

The invention of the present application relates to a system and method for correcting the output provided by printer devices. In one aspect of the invention, a method for correcting the output of a printer device includes receiving output data at a printer device, the output data describing intended output for the printer device, where the printer device prints printed output based on the output data. The method futher includes shifting the position of at least one non-matching portion of future printed output of the printer device that does not match the intended output due to a technical failure of the printer device. The shifting causes the quality of non-matching portions in future printed output to be improved. Similar aspects of the invention provide a computer readable medium including program instructions for implementing similar steps.

In another aspect of the invention, an apparatus for correcting the output of a printer device includes a printer device that provides printed output based on received output data describing intended output for the printer device. A controller in communication with the printer device causes a shift of a position of at least one non-matching portion of future printed output that does not match the intended output due to a technical failure of the printer device. The shifting causes the quality of non-matching portions in future printed output of the printer device to be improved.

The present invention allows defective output from a printer device to be improved and corrected by shifting portions of the output to the functional parts of the printer device that otherwise would be printed by the non-functional parts of the printer device. The present invention also examines various positions for shifting output and takes into account the positions of previous output and the unit of work currently being printed by the printer device, thus allowing for higher quality output.

### BRIEF DESCRIPTION OF THE DRAWINGS

FIG. 1 is a block diagram illustrating a system suitable for use with the present invention;

FIG. 2a is an illustration of example printer output corresponding to a typical receipt for a customer in a point-of-sale environment;

FIGS. 2b and 2c are illustrations of portions of a text line from the printer output of FIG. 2a;

FIG. 3 is a flow diagram illustrating a method of the present invention for correcting printer device output; and

FIG. 4 is a flow diagram illustrating a step of the method of FIG. 3 in which an amount and direction of shift to be applied to the printer output is determined.

### DETAILED DESCRIPTION OF THE INVENTION

The present invention relates to printer devices, and more particularly to the correction of errors or low quality in output provided by printer devices. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular systems provided in particular implementations. However, one of ordinary skill in the art will readily recognize that this method and system will operate effectively in other implementations. For example, the printer and processing systems usable in the present invention can take a number of different forms. The present invention will also be described in the context of particular methods having certain steps. However, the method and system operate effectively for other methods having different and/or additional steps not inconsistent with the present invention.

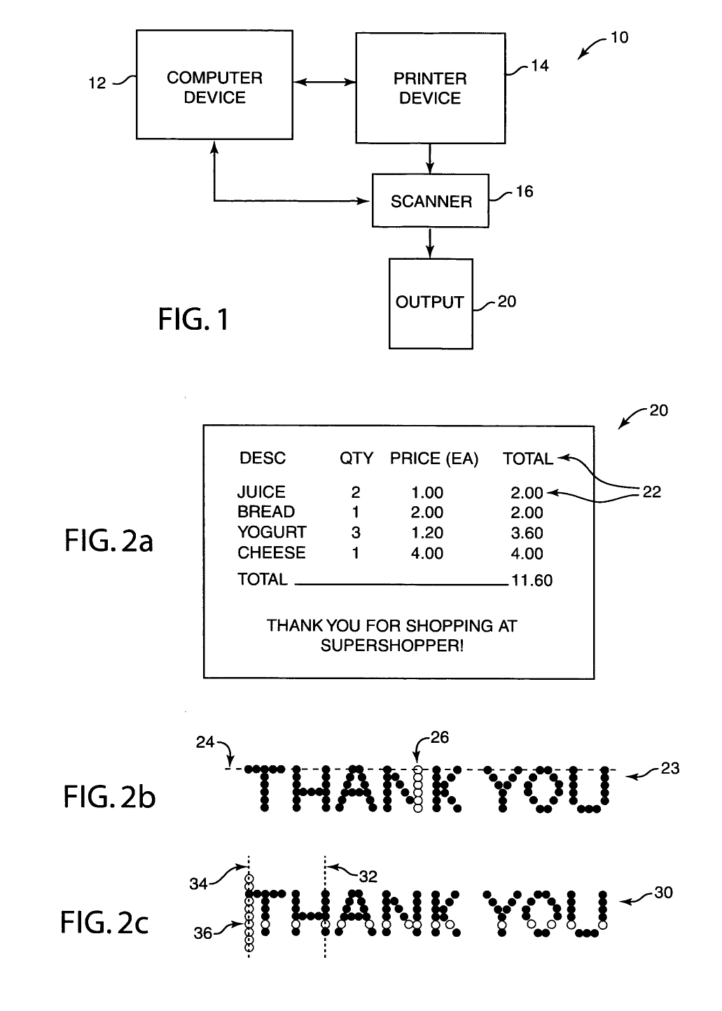

FIG. 1 is a block diagram of a system 10 suitable for use with the present invention. System 10 includes a number of components, including a computer device 12, a printer device 14, and a scanner 16 (various other components and input/output devices can be included as desired, which are not shown).

Computer device 12 can be any electronic processor or device that is able to store and/or provide data to the other components of the system 10. For example, computer device 12 can be a cash register or terminal used by a cashier or other person at a retail store or other establishment dealing with customers who are paying for items. In such an embodiment, the computer device 12 includes one or more input devices, such as a bar code reader or input keyboard, to allow the input of identifications of the items which the customer is buying, and/or prices of the items. One or more microprocessors and memory of the device 12 can hold and process pricing information, add prices, and perform other needed computations or data storage. A cash drawer, display readout, and other components can also be included. In other embodiments, the computer device 12 can be a desktop or laptop computer, mainframe computer, or other device which can send commands to printer device 14. The computer system 12 can include one or more processors (microprocessors, application specific integrated circuits, etc.), memory (RAM and/or ROM), storage capability (disk drive, optical disk, etc.), and input/output (I/O) components (network interface, input devices, output devices such as a display, etc.), as is well known.

Printer device 14 is coupled to the computer device 12 and is used to provide output, such as output 20, on a medium such as paper. Printer device 14 can be any of a variety of printing devices, but printer devices that are best suited for use with the present invention have a printing head which areas or parts of the head may fail or malfunction while other areas can continue to function correctly. For example, a thermal printer has a heating element printing head which includes multiple wires, where each wire prints a dot on the output medium. In many implementations, the printing head is almost as wide as the horizontal margins of the medium, and prints an entire horizontal row of dots at one time, i.e., perpendicular to the direction of paper flow through the printer device. One or more of the wires, however, can fail and not be able to print dots thereafter. Or, a dot-matrix or other impact printer device has a printing head which has surfaces that impress marks on a medium through a ribbon of ink or similar transferable substance, where a vertical row of dots can be printed simultaneously within a predetermined area, e.g., where multiple vertical lines and dots make up a character of a text line. Part of the printing head can fail and not print dots any longer.

In printer devices 14 which are used for POS applications, a roll or supply of paper is provided in the printing device to be printed on when a receipt is output for a customer. In many applications, the printer device 14 is included in the housing of the computer device 12 (or vice-versa), such as a terminal or cash register.

The printer device 14 can receive commands and data from computer device 12 (or other sources) and print the indicated data. The printer device 14 may also send status signals or data to the computer device 12. The printer device 14 can create printed text or images in output 20 using any well-known technique. For example, many printer devices print several small “dots” in configurations that resemble letters of text, a desired image, etc. As explained above, dots can be output using a printing head that directs the printer output onto specific portions of the output medium, as is well known to those of skill in the art. Herein, the term “printing head” is intended to describe a device component used by a printer device to print text or images on a medium, whether that device includes a unit that prints an entire row of dots or line of text simultaneously, a unit that moves back and forth across the medium, etc. A printed “row” is intended to refer to a single horizontal row of dots printed on the medium at one time, a “column” refers to a single vertical line of dots, and the term “line” is typically referring herein to a text line, i.e., a horizontal line of text characters. Often, text lines are positioned horizontally on a medium, as in POS printer devices which provide a receipt to a customer; but text lines can be positioned in other directions in other embodiments.

The output 20 can be a portion of a medium such as paper, plastic, or other material that has text, images, or information printed thereon. For example, a paper receipt can include described items bought by a customer, numerical prices of the items, and total amount due or paid. The output 20 can include any type of information, such as text, images, photos, graphs, etc.

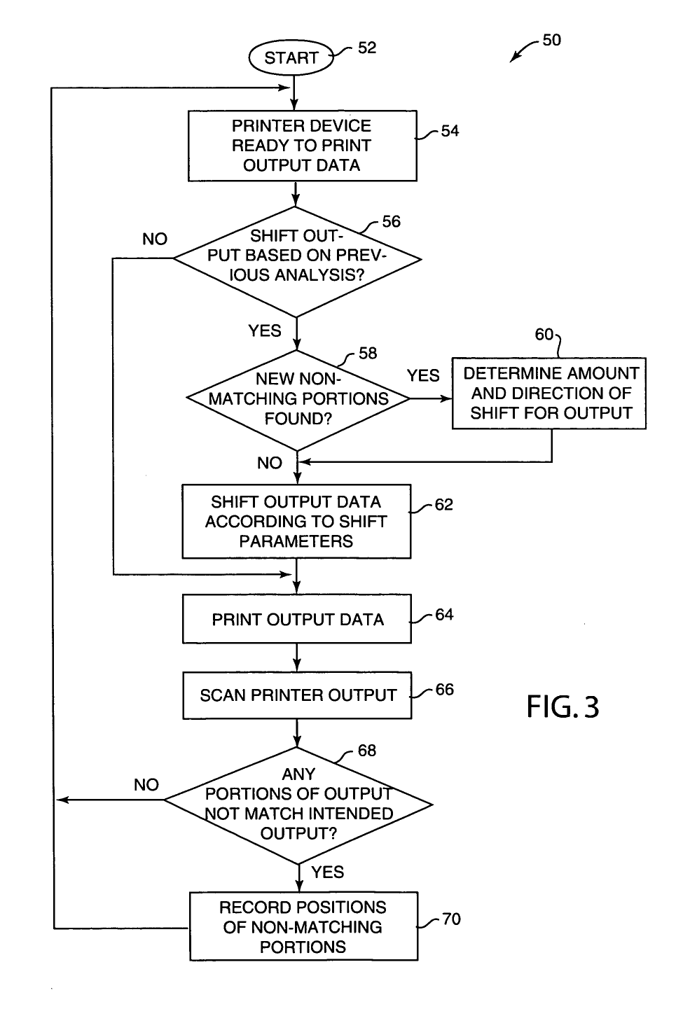

Scanner 16 is coupled to computer device 12 and/or printer device 14 and is used to monitor and examine the output 20 of the printer device 14. The scanner can receive commands from printer device 14 and/or computer device 12. Scanner 16 can be any of well-known optical scanner devices (scanners, fax machines, copiers, etc.) which includes sensors that can sense the dark and light patterns and marks on a piece of paper or other medium, recognize text or other images, and digitize the output into digital data. Scanner 16 receives the medium including the output 20 from the printer device 14 and scans the output 20 as it is providing the output to the user or customer. The scanner 16 provides the scan of the output 20 as digital data, and can send this digital scan data to the computer device 12 for analysis, e.g. evaluation of the output against the intended output, as described in greater detail with respect to FIG. 3. In some embodiments, the scanner can send the digital data to the printer device 14 if the device includes the capability to process the data as needed for the present invention.

It should be noted that the present invention can be used with any appropriate printing device which includes, or has its output provided to, a scanner. In one suitable embodiment for the present invention, the printer device 14 includes the scanner 16 for scanning its output, and the printer device 14 also includes a printer controller which can receive the scanned data, evaluate the printer's output, and perform the corrective action to the data (and/or output) as detailed herein.

The communication links between the various components of system 10 can be physical links (wire connections, network connections, etc.) or wireless links implemented via radio signals, infrared signals, etc. Computer system 12 and/or printer device 14 can also include connections to other computer systems or devices which it can communicate with. The networked devices can communicate via one or more well-known networking protocols.

FIG. 2a is an illustration of an example of output 20, in the form of a receipt for a customer at a POS environment. Receipt 20 includes various forms of information describing items the customer bought and the prices paid. Each text line 22 can extend over part or all of the horizontal width of the paper. As on typical receipts, successive text lines align descriptions or values in vertical columns for ease of reading by the customer.

FIG. 2b is an illustration of a portion 23 of a text line from the receipt 20 of FIG. 2a illustrating a thermal printer device print method. In a thermal printer device embodiment, the printing head prints a horizontal row of dots at once, such as the row marked with the dashed line 24 in FIG. 2b. By printing successive horizontal rows of dots, text characters can be formed as shown. Different printer devices may have different resolutions and sizes of dots. Images can also be similarly formed. If a failure occurs in one or more of the wires on the printing head, then no dots are printed for those wires. For example, a failure has occurred at position 26 of the horizontal row of dots 24, so that no dot is printed at that position. This failure occurs for every succeeding row of dots, causing a vertical line of “whitespace” and indicated in FIG. 2b as circle outlines.

FIG. 2c is an illustration of a portion 30 of a text line from receipt 20 of FIG. 2a, in which the printing method of a dot matrix or other impact printer is illustrated. In many dot matrix printer devices, a vertical column of dots is printed at a time by the printing head, as indicated by the line 32. Only some of the dots within the full dimensions available for printing are typically printed, as in the column 34, where only the dot on the “T” character is printed, but in which the circle outlines indicate all of the positions available for printing, including positions above and below the standard character height to allow for “descenders” and “ascenders”, i.e., parts of characters extending outside the standard character height. If a failure occurs in one or more of the dot surfaces on the printing head, then no dots are printed for those positions. For example, a failure has occurred at position 36 of the vertical column of dots 34, and this failure occurs for every succeeding column of dots, causing a horizontal line of “whitespace” and indicated in FIG. 2c as the horizontal line of circle outlines.

FIG. 3 is a flow diagram illustrating a method 50 of the present invention for correcting output mistakes in printer output. Method 20, as well as the other methods described herein, are preferably implemented using program instructions (software, firmware, etc.) that can be executed by a computer system, such as computer device 12 and/or printer device 14, and are stored on a computer readable medium, such as memory, hard drive, optical disk (CD-ROM, DVD-ROM, etc.), magnetic disk, etc. Alternatively, these methods can be implemented in hardware (logic gates, etc.) or a combination of hardware and software.

The method begins at 52, and in step 54, the printer device is ready to print output data. The output data may have been provided to the printer device 14 by computer device 12 or received from some other device or storage medium. The output data can represent any desired amount or portion of text, images, etc., and, herein, refers to the data that is to be output at one time by the printer device, i.e., in one iteration of method 50. For example, one embodiment for use with common thermal printer devices uses output data that represents a single row of horizontal dots to be printed on the printer medium with a single application of the printing head to the paper. The output data can be received by the printer device as part of a larger group of data, a “unit of work,” that will eventually all be printed, where the unit of work can vary in size in different embodiments, e.g., it can be multiple rows of dots, a text line made up of several rows of dots, several text lines, a whole page of data, an image of several rows, part of an image or text line, etc. In some cases, the unit of work can be the same as the output data size, e.g., the thermal printer can be continually provided with output data representing a single row, and prints each row as the output data is received. Similarly, a dot-matrix printer may be provided with a unit of work representing a single text character, a line of text characters, or multiple lines of text, and may print output data representing a single vertical column of dots.

In step 56, the method checks whether to shift any portions of the output data based on previous analysis. A shift in the output may or may not be required based on different criteria. In one case, a shift may be needed if a previous analysis, performed in a previous iteration of the method 50 in steps 68-70 (described below), checked the previous output of the printer device for portions of the printed output that did not match the intended output based on the output data, and found portions that did not match. If no such non-matching portions were found, then no shift of the output is needed. If non-matching portions were found, then corrective action may be needed, including the shifting of non-matching portions of the output data corresponding to the non-matching portions of the printed output, to increase the quality of future printed output and minimize the differences in the printed output from the intended output.

However, even if steps 68-70 had found and recorded non-matching portions, shift might still not be appropriate to apply to the output data being printed in the current iteration of method 50. For example, the printer device may be in the middle of printing a text line or complete image, and, if shift is applied, the output data currently being printed would be misaligned with previous output data in the same text line or image that was previously printed without shift. Thus, if the printer device is in the middle of printing a unitary portion of the output, such as a text line or cohesive image, or a unit of work that should be printed consistently, and the printer device has already printed a one or more dots in a previous iteration, then the current unitary portion or unit of work should be completely output before any shift is applied to the output data (or additional shift). In such a case, therefore, no shift should be currently determined and applied to the output, and the shift would begin with the next text line, image, or unit of work.

In the case of a printer device 14 which provides the output 20 in image form as opposed to text, so that the size of text line is unknown, the size of a text line can be determined by user or software settings or preferences. Or, when text is printed as image data rather than discrete characters or lines, the text line size can be determined from the scannedin data by the printer device 14, scanner device 16, or computer device 12 by checking for logical boundaries between text lines, e.g., when dot rows are completely “off” and are all blank space, the boundary of a line of text is determined to have been found.

In another case, a shift may be needed in this iteration of the method if a shift were determined and performed in one or more previous iterations. To keep successive rows or columns of dots aligned with previously-shifted rows or dots, successive output of the printer should be shifted by at least the same amount.

Thus, if no portions of the output data are to be shifted, then the process continues to step 64, described below. If any output portions are to be shifted, then in step 58, it is checked whether any new non-matching portions were found, i.e., found in the last iteration of method 50. Such new non-matching portions can be the first time non-matching portions have been found for the printer device, or new non-matching portions can be found in output data that has previously been shifted. When step 68 (below) was last performed, if no non-matching portions were found, then the process continues from step 58 to step 62 to shift the data using previously-determined shift parameters, as described below, with no new determination of shift needed.

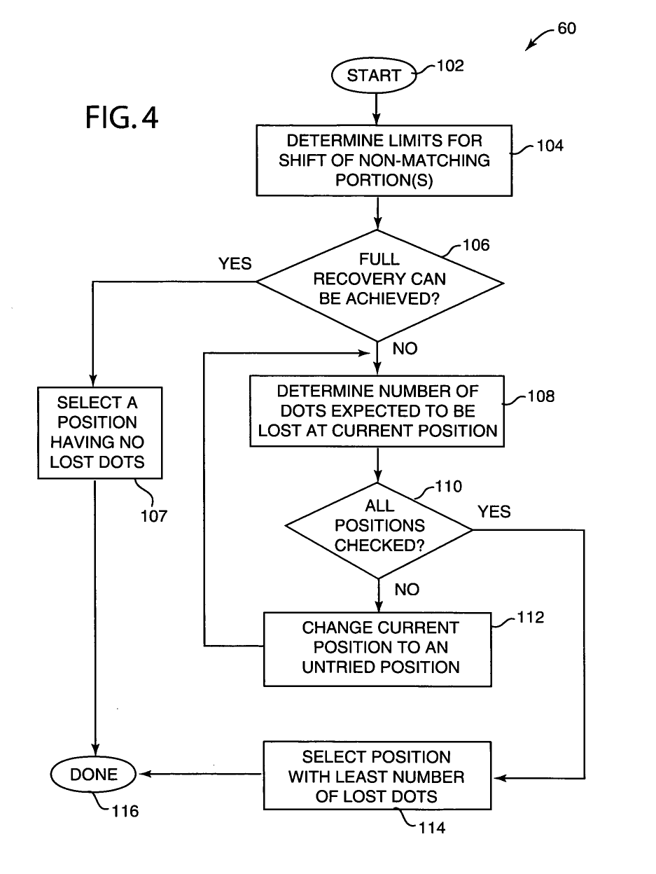

If, however, new non-matching portions were found, then in step 60, an amount and direction of shift is determined for the non-matching portion(s) of the output data. This can be accomplished, for example, by a processor in printer device 14 or scanner 16, the computer device 12, etc., which can analyze the data from the scanner 16 and the non-matching portions as recorded by step 70 below. Any previous shift can also be taken into account. Since the printer device may be malfunctioning and providing incorrect output in only particular positions of the printed output row or line, the printed output may be able to be shifted away from those malfunctioning positions and into positions in which the printing head is functioning properly. In a described embodiment, such as for use with typical thermal printer devices, the output data can be shifted by a fixed number of “dots” either left or right in order to position the output at functioning areas of the printer device and to position blank space (“whitespace”) at the malfunctioning positions where the incorrect output is expected to be generated. Several factors can be used in determining whether shift is to be applied and the amount of shift, including factors such as the available space, the amount of lost dots, etc. If there are multiple non-matching portions in the output data, this can be taken into account in the determination of shift. Examples of particular methods and steps that can be used in this step are described in greater detail with respect to FIG. 4. The process then continues to step 62.

With the amount and direction of shift determined in step 60, these “shift parameters” are stored and made accessible to future iterations of steps 56 and 62, where step 62 can use the shift parameters to shift the position of the next appropriate output data that is received to be printed by the printer device. Any previously-determined shift parameters are superseded by these newly-determined shift parameters.

In step 62, the output data is shifted in a manner according to the shift parameters that were determined in step 60 in the current iteration or a previous iteration of method 50. For example, in a described embodiment, this shifting includes moving the non-matching portions of the output data by a predetermined amount and in a predetermined direction so that at least some parts of the non-matching portions can be printed by functioning areas of the printing head of the printer device. In a thermal printer embodiment, the shift is typically left or right (perpendicular to the direction of paper travel through the printer), while in a dot-matrix printer, the shift can be up or down (parallel to the paper travel direction). In the described embodiment, the shift can provided for an entire row or column of dots; in other embodiments, the shift can be applied to just the non-matching portions.

The shift can be implemented to the output data within the memory of the printer device 14 (or computer device 12) by changing the positions of output data in the current data being printed. In alternate embodiments, such as with impact printers, the shift may not be implemented by modifying the output data, but rather can be implemented by moving the print medium back and forth so that the functional part of the printing head can be used. For example, the paper can be “stepped” or moved a fraction of its normal amount, a portion of a text line printed with the functional area of the printing head, and then the medium is moved to another position to print the remainder of the text line with the functional area of the printing head. This can be implemented within step 64, described below. In some embodiments of impact printers, a failure may be caused by a ribbon rather than the print head; if such a failure is determined, in some embodiments the corrective action can include adjusting the ribbon, for example.

In step 64, the printer device prints the output 20, e.g. on paper or other medium, using the output data that may have been manipulated in step 62 as determined above. In step 66, the printed output is scanned so that the output can be monitored. As indicated in FIG. 1, this step is typically performed using a scanner device 16, which can scan the output provided in step 64 using any of various well-known techniques, e.g. optically. Depending on the embodiment, the scanner may scan, at one time, more than a single row of dots, an entire unit of work, or less than an entire unit of work; the printer device can know at what positions the scanner device is, and vice-versa. The scanner converts scanned images to digital data and provides that data to a processor which can evaluate and, if necessary, modify the data, such as a processor within the printer device 14, or the computer device 12.

In step 68, the method checks whether any portions of the current printed output do not match the intended output. As indicated above, this step can be performed by a processor in the printer device 14, in the computer device 12, or in the scanner 16.

To determine if portions do not match the intended output, the method can perform any appropriate comparison procedure, e.g., a bitmap comparison, or an “overlay” of the intended output data over the current output data. After compensating for any shifts and differences that may be due to previous corrections, the current output is compared to the intended output. The outputs can be compared row by row of dots, or by some other convenient division. It should be noted that a comparison can be performed after every printed output of the printer device, e.g., after every dot row, or text line, etc. The output printed in step 64 and scanned in step 66 may have been shifted in step 62, and yet non-matching portions may still be found in step 68. This may be due, for example, to previous iterations of step 68 not having found all of the non-matching portions of the output, e.g., if some dots in non-functional positions were not previously printed. The present invention thus can continually improve the shifting of printed output as more output is scanned. In some embodiments, to optimize the system, the scanner can be activated when predetermined criteria are met: for example, for units of work that will cover most dot rows to be printed, or for units of work that have dot rows in areas not recently evaluated (within a predetermined number of output iterations).

If the current printer output matches the intended output, then no additional compensation need be made and the process returns to step 54. If any portions of the current printer output do not match the intended output, then in step 70, the positions of the non-matching portions are recorded. For example, in a thermal printer that prints a row of dots at a time, the location of each non-matching dot can be recorded. In a dot-matrix printer device, the vertical location of non-matching dots can be recorded. Other embodiments may need to record coordinates and dimensions of non-matching portions. The recorded non-matching positions can be stored in memory, disk, or other storage device. These non-matching positions of the printed output are correlated with corresponding positions of later output data in later iterations of step 60.

The process then returns to step 54 to await another command to print output data. If more output data from the originally-received unit of work still needs to be printed, then step 56 can be immediately performed without waiting for additional output data at step 54.

FIG. 4 is a flow diagram illustrating step 60 of FIG. 3, in which the amount and direction of shift is determined for non-matching portions of the output of the printer device. The process begins at 102, and in step 104, limits are determined for the shift of the non-matching portion(s) that were found in the printed output data. These limits prescribe the maximum amount of shift that can be applied to the non-matching portion to correct for the errors in output, and the non-matching portion may not be shifted past these limits.

The limits can be based on a number of factors, including alignment with previous printed output, and the available printable dimensions of the printer device. Limits to the amount of shift can be based on additional and/or alternative factors in other embodiments.

Alignment is desired so that the previous, unshifted lines or portions of output from the printer device are approximately aligned with the shifted lines or portions without looking too offset or misaligned. Since there are some aesthetics involved in determining how much maximum misalignment should be allowed, and the amount of allowable alignment can vary in different printer devices based on resolution, printed font, etc., the maximum misalignment can be determined by the printer device developer or manufacturer, and/or can be provided as an adjustable preference for the user of the printer device. In some embodiments, maximum misalignment can be a standard and fixed amount, or in other embodiments, can vary depending on position, etc.

The available printable dimensions of the printer device also limits the amount of shift because no output can be printed beyond those dimensions; thus, shift must be constrained to maintain output within these dimensions. For example, in thermal printer devices, the available printable horizontal dimension that limits shift is based on the width of the printing head (while the vertical dimension is unknown and can be based on the amount of paper available, etc.). In dot matrix printer devices, the available vertical dimension for a column of dots is based on the height of a typical text line for that printer device. Depending on the application or embodiment, some portions of the output may require strict alignment or may be so close to the printable area of the printer device that effectively no shifting and correction of the non-matching portion is allowed.

In some alternate embodiments, the amount of the shift is fixed, e.g., a fixed number of dots, and only the direction of the shift need be determined. If the limits prevent the fixed amount of shift, then it is not performed.

In the described embodiment, the entire output data including the non-matching portion, i.e. the entire row or column of dots, is shifted, rather than just the non-matching portion (dots) itself relative to the rest of the output data. This embodiment assumes that there is some available space beyond the normal margins of output data sent to the printer device in which to shift the entire row or column. Thus, depending on the amount of dots in a particular row or column that are to be printed, and depending on how close to the margins of the printable dimensions that the output data extends, the amount of shift can vary from line to line. For example, a row of dots in text within two columns in the middle of the available horizontal space may be able to be shifted horizontally a greater amount than a row that extends close to the margins of the horizontal printable space.

In other embodiments, the non-matching portion can be shifted relative to the other output data in which it is located. In such embodiments, the available printable dimensions may not be a factor unless the non-matching portion desired to be shifted is located close to a margin of the available space.

In step 106, it is checked whether a full recovery of the non-matching portion can be achieved. A full recovery may not be achievable if the limits to the shift determined for the non-matching portion in step 104 are so restrictive that the non-matching portion cannot be sufficiently shifted in any direction to completely avoid the loss of “dots” printed or the other loss of quality due to the malfunction of the printer device. If the full recovery of the non-matching portion can be achieved within the established limits, the process continues to step 107, where a shifted position is selected in which no dots are lost. The shift may be in either direction away from the original position, and the shift amount should be the least amount that provides no lost dots. In addition, the limits determined in step 104 may constrain the direction and amount of shift, e.g., if a limit in one direction forces dots to be lost, then the shift is provided in the opposite direction. Furthermore, in some embodiments, weighting can be applied based on the shift selected for previous printed output, and this weighting can influence the direction and magnitude of the shift. For example, if a left shift was selected for the print line just previous to the current print line, then a position shifted left for the current output data can be weighted more than a position shifted right, since the left shift will cause the current line to be more closely aligned to the previous line. Weightings can be provided for the direction of previous shift, and or the magnitude of previous shift. After step 107, the process is complete at 116.

If full recovery cannot be achieved, then the process continues from step 106 to step 108, the number of printed dots which are expected to be lost at the current position of the output data (or just the non-matching portion, in appropriate embodiments) are determined. In this step, the “current position” is initially the original, non-shifted position of the output data. In later iterations of this step, the current position is a shifted position. Lost dots are those dots which would not be printed due to the malfunction of the printer device. The amount of dots lost without shift is determined from the comparison made between the printed output and the intended output, as in step 68 of FIG. 3 and the amount of dots lost at a shifted position is determined by examining the position of the dots after shift would be applied to the output data in the current iteration. In the described embodiment, the number of lost dots is determined for the entire row or column of dots, not just for the non-matching portion, since the entire row or column is shifted. Moving the output data in one direction may eliminate one lost dot, but it may create another lost dot by shifting a printed dot into the non-printing, malfunctioning area of the printing head. In other embodiments, only the non-matching portion is examined for lost dots.

In step 110, it is checked whether all the positions of the output data (or just the non-matching portion, in appropriate embodiments) have been checked for the amount of dots lost in step 108. “All” of the positions can be a predetermined number of possible positions to which the output data can be shifted, and/or is limited by the limits determined in step 104. Typically, the shifted positions include positions to the left and right of the original positions for thermal printer devices, and positions above and below the original position for dot-matrix printer devices. If all the positions have been checked, then the process continues to step 114, described below.

If all the positions have not been checked, then in step 112, the current position of the output data (row or column of dots, or just the non-matching portion in appropriate embodiments) is changed to a different position which has not yet been checked in step 108. The process then returns to step 108 to determine the number of dots expected to be lost at the new position. For example, there can be a predetermined number of positions in which the output data can be positioned, each position requiring a different amount of shift in a left or right (or, up or down) direction. The maximum number of positions can be determined by the resolution of the dots making up images that are printed, and the limits of shift as determined previously. By shifting the output data by one dot, e.g., to the left, another position is obtained. In some embodiments, the output data can be shifted by a multiple number of dots for each position. Furthermore, similar to step 107, weighting can be applied based on previously-applied shifts to previous output data to bias the current shift in a particular direction and/or by a particular magnitude, and/or bias the available positions for shifting. In some embodiments, such weighting may cause a position to be favored which causes more lost dots to occur than other positions, if alignment is weighted strongly, for example.

Once all positions have been checked to determine the amount of lost dots at each of those positions, then in step 114, the process selects the position that provides the least number of lost dots. This is the position to which the output data should be shifted, and can be expressed as a direction (e.g., left or right) and amount (magnitude) of dots relative to the original position of the output data. These shift parameters are provided to the computer device 12, printer device 14, or other component to be used when next printing output from the printer device. The process 60 is thus complete at 116.

In some cases, the same amount (or the approximately the same amount, within a predetermined threshold of each other) of dots will be lost in two or more different positions, and this amount is the least amount of lost dots among the possible positions. In such cases, the position that is closest to the original position can be selected in step 114, since this position minimizes the column shift and the misalignment that may occur between the current output and previous output.

Sometimes, multiple non-matching portions may occur in output data, e.g. multiple areas or dots of a printing head can fail. These cases can be handled by determining the dropped dots as a whole, for the entire output data (such as the entire row of dots). Weighting can also be applied in this type of situation, such that a portion or position having more dots lost on the row (or column) may have more influence over the shift than a different portion or position having less lost dots on that row. For example, a ratio of the amount of dots lost to the dot height of a printed portion, such as a text line, can be used to establish a weighting for each position. As an example, in a printed text line, at its current position the line will lose 4 dots in a first column and 2 dots in a second column. Assuming a dot height for the line of 8 dots, this comes to 50% and 25%, respectively, for a total summed score of 75. If the line is shifted left, then 1 dot is lost in the first column and 4 dots in the second column; and if the line is shifted right, then 1 dot is lost in the first column and 4 dots in the second column. In both cases, this comes to 12.5% and 50%, for a total score of 62.5. Thus, shifting the line left or right scores less and thus is preferable to the original position, since less dots will be lost. Either left or right shift could be chosen, and this choice can be further biased based on the direction the previous text line was shifted to keep the lines aligned.

In addition, weightings can be applied based on dots adjacent to the dropped dots, such that if dots are to be printed adjacent to the lost dots, the score can be lowered based upon a predetermined method. This embodiment is based on the fact that the quality of text or images is typically maintained even when dots are lost, as long as other dots close to the lost dots are printed. For example, the total weighting score in the example above can be lowered by 2 for each dot printed adjacent to a dropped dot. In some embodiments, diagonal dots adjacent to a lost dot can also be considered, and may lower the score by a different amount (e.g., by less amount) than orthogonally-adjacent dots. \Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for correcting the output of a printer device, the method comprising:
receiving output data at a printer device, the output data describing intended output for the printer device, wherein the printer device prints printed output based on the output data; and
shifting the position of at least one non-matching portion of future printed output of the printer device that does not match the intended output due to a technical failure of the printer device, wherein the shifting causes the quality of the at least one non-matching portion in the future printed output to be improved.

2. The method of claim 1 wherein the shifting of the non-matching portion of future printed output includes shifting a position of at least one non-matching portion of future output data received at the printer device, the non-matching portion of the output data having provided the non-matching portion of the printed output.

3. The method of claim 2 wherein the non-matching portion of future output data corresponds to a portion of the printed output which the printer device did not print correctly on a print medium due to the technical failure.

4. The method of claim 3 wherein the portion of the printed output that did not print correctly includes at least one dot that is not being printed or is being printed at reduced quality.

5. The method of claim 1 further comprising evaluating the printed output of the printer device to determine whether any portions of the printed output do not match the intended output.

6. The method of claim 5 wherein evaluating the printed output includes reading the printed output using an input device.

7. The method of claim 2 wherein the output data is part of a unit of work received by the printer device, wherein the unit of work includes data for at least one line of text, and wherein the shifting of future printed output is not performed unless an entire line of text can be shifted.

8. The method of claim 7 wherein shifting the position of at least one non-matching portion includes shifting the non-matching portion left or right on a row of the output data corresponding to a horizontal row of the printed output.

9. The method of claim 8 wherein the shifting of the non-matching portion includes shifting an entire horizontal row of printed output.

10. The method of claim 1 wherein the shifting of the position of the non-matching portion includes shifting the non-matching portion up or down on a vertical column of dots in the printed output.

11. The method of claim 10 wherein the shifting of the non-matching portion of the printed output includes moving a print medium such that a non-failing part of the printer device can provide printed output at the non-matching portions of the printed output.

12. The method of claim 2 wherein the amount and direction of the shift of the non-matching portion of future output data is determined based on the number of printed dots lost at each of a plurality of possible shift positions, wherein the position providing the least number of lost dots is selected.

13. The method of claim 2 wherein the amount and direction of the shift of the future non-matching portion of the output data is determined based on an alignment of the non-matching portion with output data previously printed on a print medium.

14. The method of claim 13 wherein the shift of the future non-matching portion of the output data is influenced by a weighting based on the amount of shift provided for previous printed output.

15. The method of claim 1 wherein the shifting of the non-matching portions includes recording the positions of the non-matching portions so that the future printed output of the printer device can be shifted.

16. An apparatus for correcting the output of a printer device, the system comprising:
a printer device that provides printed output based on received output data describing intended output for the printer device,
a controller in communication with the printer device that causes a shift of a position of at least one non-matching portion of future printed output of the printer device that does not match the intended output due to a technical failure of the printer device, wherein the shifting causes the quality of future non-matching portions in the future printed output to be improved.

17. The apparatus of claim 16 wherein the controller shifts a position of at least one non-matching portion of future received output data, the non-matching portion of the output data having provided the non-matching portion of the printed output.

18. The apparatus of claim 17 wherein the non-matching portion of future output data corresponds to a portion of the printed output which the printer device did not print correctly on a print medium due to the technical failure.

19. The apparatus of claim 18 wherein the portion of the printed output that did not print correctly includes at least one dot that is not being printed or is being printed at reduced quality.

20. The apparatus of claim 16 wherein the controller evaluates the printed output of the printer device to determine whether any portions of the printed output do not match the intended output.

21. The apparatus of claim 20 further comprising a scanner coupled to the controller and operative to read the printed output of the printer device.

22. The apparatus of claim 17 wherein the controller causes the shift of an entire horizontal row of printed output, including the non-matching portion, in a left or right direction on a row of the output data corresponding to a horizontal row of the printed output.

23. The apparatus of claim 22 wherein the printer device is a thermal printer device.

24. The apparatus of claim 16 wherein the controller causes the shift of the position of the non-matching portion up or down on a vertical column of dots in the printed output.

25. The apparatus of claim 24 wherein the printer device is a dot matrix printer device or other impact printer device.

26. The apparatus of claim 17 wherein the amount and direction of the shift of the non-matching portion of the output data is determined based on the number of printed dots lost at each of a plurality of possible shift positions, wherein the position providing the least number of lost dots is selected.

27. A computer readable medium including program instructions to be implemented by a computer, the program instructions for correcting the output for a printer device, the program instructions implementing steps comprising:
receiving output data at a printer device, the output data describing intended output for the printer device, wherein the printer device prints printed output based on the output data; and
shifting the position of at least one non-matching portion of future printed output of the printer device that does not match the intended output due to a technical failure of the printer device, wherein the shifting causes the quality of the at least one non-matching portion in the future printed output to be improved.

28. The computer readable medium of claim 27 wherein the shifting of the non-matching portion of future printed output includes shifting a position of at least one non-matching portion of future output data, the non-matching portion of the output data having provided the non-matching portion of the printed output.

29. The computer readable medium of claim 28 wherein the non-matching portion of future output data corresponds to a portion of the printed output which the printer device did not print correctly on a print medium due to the technical failure, and wherein the portion of the printed output that did not print correctly includes at least one dot that is not being printed or is being printed at reduced quality.

30. The computer readable medium of claim 27 further comprising evaluating the printed output of the printer device to determine whether any portions of the printed output do not match the intended output, including reading the printed output using an input device, and wherein evaluating the printed output includes comparing the printed output to the intended output.
